(19) United States
(12) Patent Application Publication
(10) Pub. No.: US 2004/0028802 A1
(43) Pub. Date: Feb. 12, 2004

(54) Unit for the production of ising sugar from crystalline sugar or invert sugar

(76) Inventor: Michael Meyer, Heppenheim (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/450,939

(22) PCT Filed: Nov. 9, 2001
(86) PCT No.: PCT/EP01/12956

(30) Foreign Application Priority Data
Jan. 12, 2001 (DE) 101 01 464.3

(51) Int. Cl. A23G 3/00

(52) U.S. Cl. 426/658

(57) ABSTRACT

During the fine-milling of sugar, the fine material deposited on the surfaces is amorphous and hygroscopic. Excess water which is taken up is released during the subsequent recrystallisation and can cause the formation of clumps. Conventionally, intricate additional measures have been necessary in order to avoid the above. According to the invention, a nozzle (8) for injecting steam is provided in a mill (3), or in a pneumatic supply line (6), connected thereto. The recrystallisation time is reduced by means of the injecting of steam. A pneumatic mixing head (15) is arranged in the frustum-shaped lower section (16) of a collecting chamber (7). Blasts of air are injected into the collecting chamber (7) at short intervals by means of the mixing head (15). The fine-milled sugar collecting there is thus aerated, whilst the recrystallisation continues. The excess water released during the recrystallisation is thus driven off. The icing sugar can be removed in recrystallised form and can be stored and transported without further treatment.

The invention relates to an apparatus for producing powdered sugar according to the introductory clause of claim 1.

It is based on an apparatus such as described in the product literature of the applicant “Mechanical Cyclone-Milling Process.” The product literature states that the apparatus is intended for the fine-milling of sugar.

The cyclone mills described in the product literature correspond in construction and function to the mills of German published application 2,353,907 or 196 03 627. A more detailed description of mills of this type is seen in German patent application 100 55 130 to which specific reference is made. Such mills have an input opening that permits air to be fed in. A stream of air is sucked in through a rotor equipped with milling tools that acts like a radial fan as well if necessary through upstream and downstream blowers, the air stream carrying the material being milled through the mill and in many cases as also shown in the cited product literature serving to move the fine-milled material from the outlet of the mill.

In the fine milling of sugar the destroyed crystal surface is initially amorphous. The amorphous sugar tends to convert back into crystalline form. The amorphous surface is very hygroscopic and takes up water even from relatively dry air, e.g. with a relative humidity of 10%. The taken-up water reduces the activation energy that is necessary to initiate recrystallization. The higher the humidity, the faster the recrystallization. The moisture taken up by the amorphous sugar exceeds the ability to hold water of the crystal sugar. Thus excess moisture is shed by the recrystallized sugar. This leads to an increase of the humidity level in the air that is in the interstices of the mass of finely milled sugar. The trapped air can be substantially more humid than the surrounding air in the storage area. As a result of the increased humidity, the surface of the sugar crystals is dissolved. This leads to bridges between the sugar crystals which harden after drying of the sugar so that the crystals form clumps.

In order to avoid clump formation one is forced on the one hand to control the recrystallization process and on the other hand to facilitate an unhindered carrying-off of the freed water. According to a conventional method the finely milled sugar is loaded into air-permeable bags that are stored in air-conditioned rooms. The relative humidity is set such that recrystallization is complete after 24 to 48 hours. During this slow recrystallization natural air exchange prevents an excess increase of humidity insid the stored mass. Frequent restacking of the bags increases the air exchange.

It is an object of the invention to provide an apparatus according to the characterizing clause of claim 1 wherein the finely milled sugar is produced in recrystallized form and is immediately ready without further processing for transport or storage.

This object is achieved by the characterizing clause of claim 1.

With the apparatus according to the invention, feeding steam into the conveyor conduit or directly into the mill produces a humidity which shortens the recrystallization time so that the recrystallization takes place in the collector and is mainly over by the time it is full. Feeding steam into the conveyor conduit or directly into the mill has the advantage that it takes place just when the fine-particulate material is being intensively moved about by humid air. During the recrystallization the finely milled sugar is continuously or periodically aerated by the compressed air that is blown in from below. In this manner the freed excess moisture is carried off and the finely milled sugar is cooled by the latent heat of evaporation to ambient temperature.

According to the feature of claim 2 a part of the clean air that has been heated by the milling process is recirculated. In this manner the energy needed to turn the freed water into steam during recrystallization is reduced.

As a result of the feature of claim 3 a rotary movement is created in the collector. This avoids dead spots.

According to claim 4 the invention is related to a mixing head that has proven itself very effective.

As a result of the feature of claim 5 a programmed control of the fed-in compressed air is possible, in particular feeding in the air as periodic pulses at predetermined intervals.

The features of claims 2 to 5 are known per se in pneumatic mixers, e.g. from German patent 1,070,905, German published application 1,104,801, German patent 1,152,877, German patent 1,172,934, and German patent 1,432,030. A detailed description can be found in German patent application 100 07 718.8, to which specific reference is made.

The drawing serves for describing the invention with reference to a simplified illustrated embodiment:

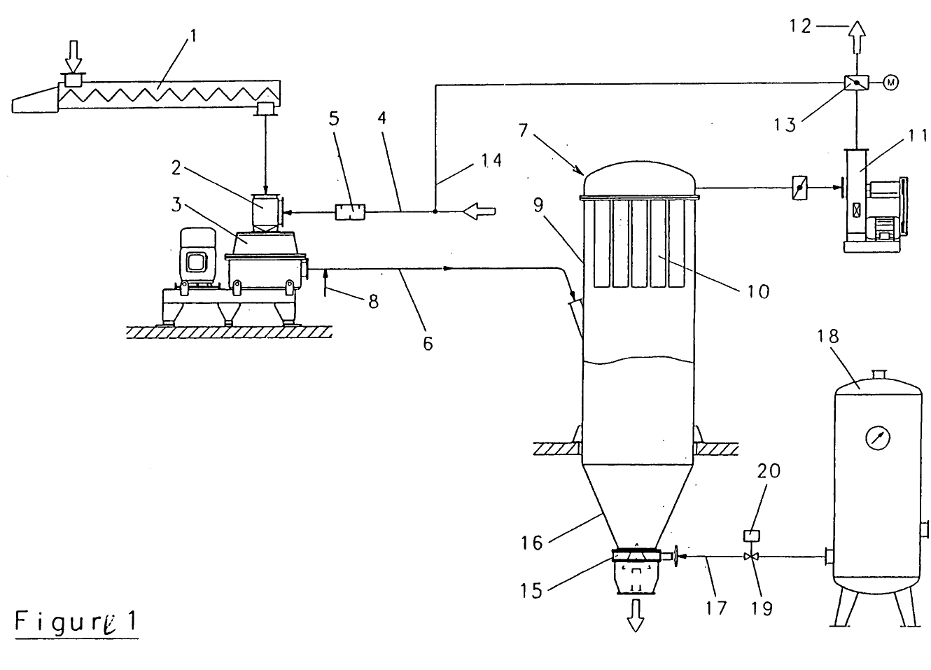

FIG. 1 schematically illustrates an apparatus according to the invention;

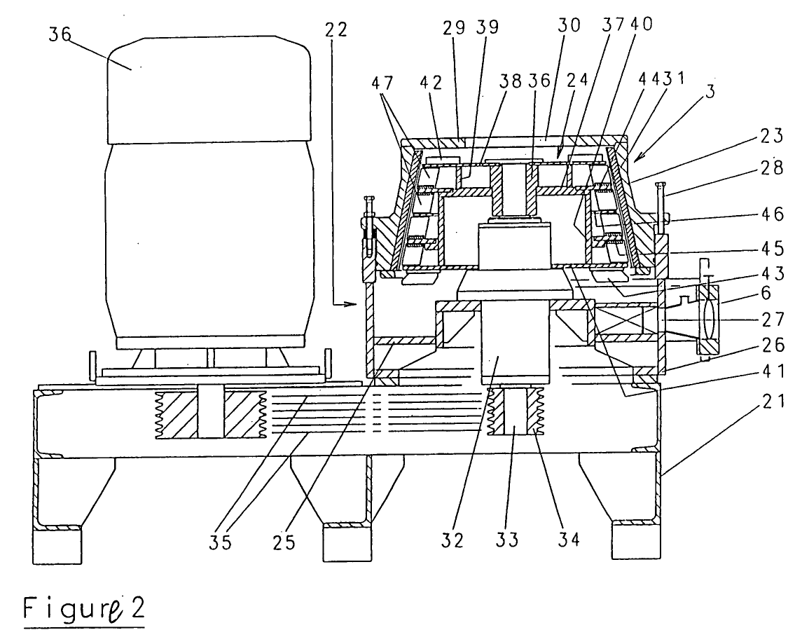

FIG. 2 shows a longitudinal section through a mill with its drive (not in section);

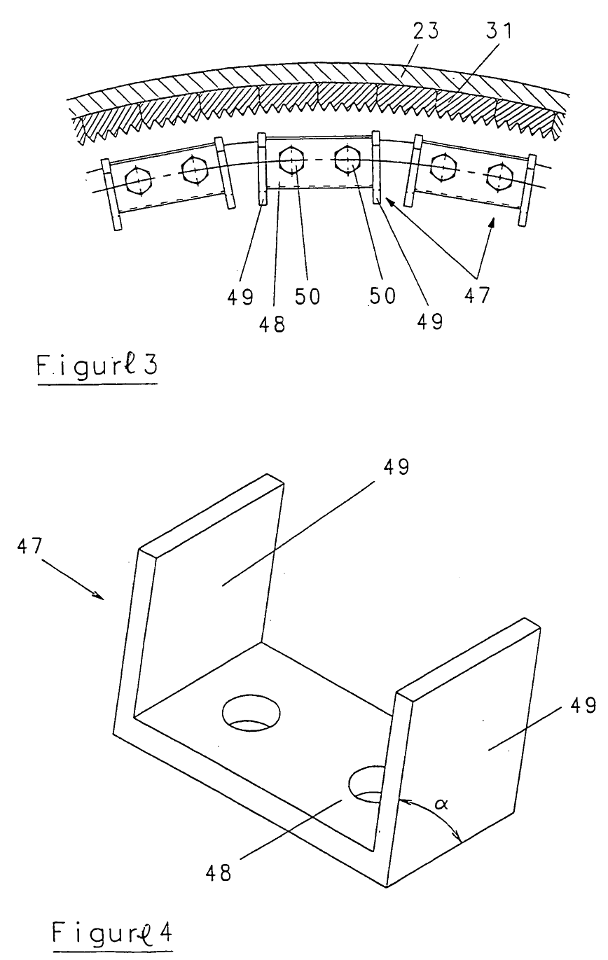

FIG. 3 shows a detail of the mill in cross section;

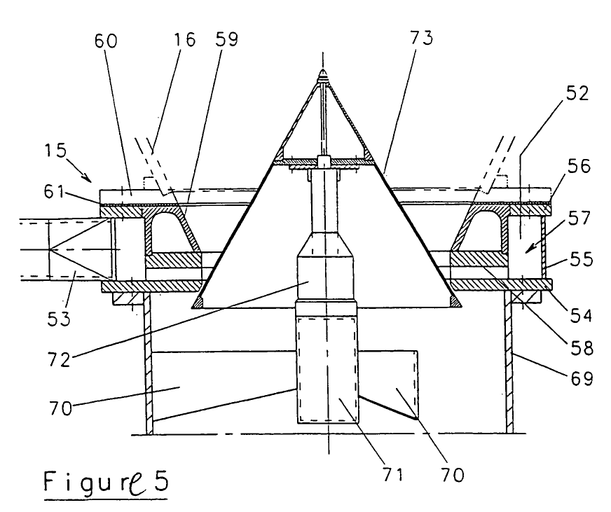

FIG. 4 shows another detail in perspective;

FIG. 5 is a vertical section through a mixing head;

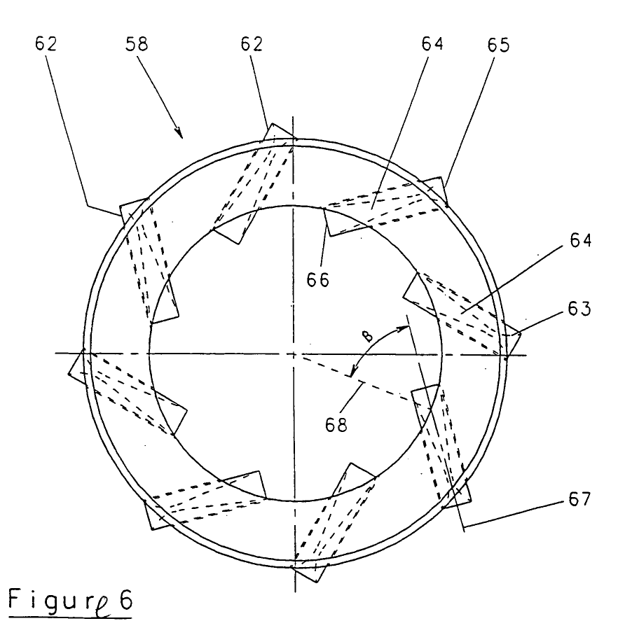

FIG. 6 is a top view of a detail of the mixing head.

An output device, e.g. a cell-wheel loader, takes sugar of a particle size smaller than about 2 mm out of an unillustrated silo. The sugar is fed as a uniform stream through a conveying device, e.g. an auger 1, to an intake 2 of a mill 3 that is described in more detail below. A stream of air that can contain fresh air and recirculated air is sucked via an intake line 4 and a sound muffler 5 into the intake 2 and moves with the sugar along the path through the mill and carries the milled fine particulates through a pneumatic feed conduit 6 into a collector 7. A nozzle 8 connected with an unillustrated supply of steam blows dry steam into the feed conduit 6 immediately downstream of the mill 3. The nozzle 8 can also, unlike what is shown in FIG. 1, open directly into the mill 3.

The finely divided particles are separated from the air stream in the collector 7 partly by inertia and partly by a filter 10 mounted in a cylindrical upper part 9 of the collector 7. The clean air separated from the particles is sucked out by a radial fan 11 and at least partially vented to the atmosphere via a chimney 12. A motor-driven valve 13 can redirect a portion of th clean air via a bypass 4 into the intake line 4.

The separated-out fine particles pile up in the collector 7. As soon as a certain depth is reached a mixing head 15 fixed at a lower end of a frustoconical downwardly tapering lower part 16 of the collector 7 blows in pulses of compressed air at short intervals of for example 20 sec as is known in the above-described pneumatic mixers. With each pulse the fine particles are loosened up and move upward on the wall of the rotation-symmetrical collector 7 in a spiral. This produces a rotating particle column that breaks down at the end of each compressed-air pulse. Before the particles resettle back into a stable heap, another pressure pulse takes place.

The necessary compressed air is fed to the mixing head 15 via a compressed-air line 17 from a pressurized-air source 18. Air flow is controlled by a valve 19 which is operated by a controller 20 according to a predetermined program. The pressurized-air source 18 is fed by an unillustrated pressurized-air line or a compressor.

When the maximum depth is achieved in the collector, the pulsed periodic air feed is stopped. Then the collector 7 is emptied.

In order to operate continuously, preferably a second collector not shown in the drawing is provided, also equipped in a lower region with a nozzle for feeding in pressurized air. An unillustrated diverter alternately feeds the two collectors so that one of the collectors is always available to receive fine particles coming from the mill while the other is being emptied.

The mill 3 is mounted on a machine frame 21. It is comprised of a housing 22, a stator 23, and a rotor 24. The housing 22 has a floor 25 and a cylindrical side wall 26 centered on an upright axis. The wall 26 is formed with an outlet port 27 to which the pneumatic feed conduit 6 is connected tangentially of the wall 26.

The stator 23 is shaped as an upwardly tapering frustocone. It sits like a cover on the housing 22 and is vertically adjustable by screws 28. It is covered by an annular disk 29 that defines an intake opening 30 for the material to be milled and the sucked-in air. The inner surface or the stator 23 is provided with ridged armor 31.

A bearing housing 32 in the floor 25 holds a shaft 33 of the rotor 24. It carries in turn on its lower end a belt wheel 34 and is driven by V-belts 35 at high speed by a motor 36 that sits adjacent the mill on the frame 21. The upper end of the shaft 33 is connected to the rotor 24. It has a base body comprised generally of a hub 36, a support ring 37 carried on it, a cover disk 38 that is supported by a brace cylinder 39 on the support ring 37, a cylinder 40 that is fixed on the lower side of the support ring 37, and an annular floor plate 41 that is connected with the cylinder 40 and that contains the bearing housing 32. The cover disk 38 carries ribs 42 and the lower side of the base plate 41 carries fan vanes 43. The outside of the cylinder 40 carries two superposed annular tool supports 44 and 45. Between them there is a middle ring 46 that is also connected with the cylinder 40. The floor plate 41, lower tool support 45, middle ring 46, upper tool support 44, and cover disk 38 are spaced uniformly one above the other. The outside diameter is the same as that of the frustoconical stator 23. Each tool support 44 and 45 is provided with a plurality, e.g. 30 to 40, of milling tools 47 that are arranged on the outer edges of the lower and upper faces in evenly spaced rings. Each milling tool 47 has a rectangular base plate 48 fixed to the respective tool support 44 or 45. Their two short ends are provided with upright milling members 49. The milling members 9 are rhombic. The angle α between their adjacent edges corresponds to the cone angle of the stator 23. The milling tools 47 are fixed in pairs by screws 50 on the tool supports 44 and 45 so that each milling tool 47 sitting on the upper side is directly opposite a milling tool 47 on the lower side. The outer edge s of the milling tools 47 form with the inner surface of the armor 31 a narrow gap, the so-called milling gap. The width of the milling gap is adjustable by means of screws 28.

FIG. 5 shows an annular mixing head 15 that is fixed to the partially shown frustoconical lower part 16 of the collector 7. The mixing head has an annular rectangular-section chamber 52 which is connected via an input fitting 42 or a plurality of such fittings distributed uniformly about its periphery with the compressed-air line 17. The chamber 52 is enclosed like a torus by walls, in particular by a base ring 54, an outer wall 55, a cover ring 45, and a center wall 57.

The latter is formed as layers. At an inner edge of the floor ring 45 there is a nozzle ring 58. It defines a circular opening that is the same as the opening of the floor ring 54. The nozzle ring 58 carries a middle ring 59 shaped like an inverted U. A flange 60 that is welded to the lower edge of the lower part 16 covers both the cover ring 45 as well as the middle ring 59. Between the flange 60 on one side and the cover ring 45 and middle ring 59 on the other side is an annular seal 61 of elastic material. The cover ring 45 is connected by unillustrated screws with the flange 60. The nozzle ring 58 and the middle ring 59 are clamped between the base plate and flange 60.

The nozzle ring 56, as shown in FIG. 6, is provided with a total of eight uniformly spaced peripheral bores. They extend horizontally between the cylindrical radial inner and outer edges of the nozzle ring 58. Each bore holds a tube 62. It has a cylindrical outer surface and an inner surface 63 formed as a Laval nozzle. It defines a nozzle passage 64 that extends at first like a trumpet from the intake opening 65 toward the outlet 66 and spreads conically after a region of minimal cross section. The axis 67 of each nozzle passage 64 forms with a respective radial line 68 an acute angle β. The nozzle passages 64 thus have both radial and tangential components. The tangential components are the same for all the nozzle passages and extend at the same angle relative to the axis of the mixing head. It is also possible, unlike in the illustrated embodiment with the horizontal nozzle passages, for them to extend somewhat upward.

The lower face of the floor ring 54 is flanged to an outlet fitting 69. It holds on support arms 70 a coaxial cylinder 71. This is connected with a closing cone 73. In the closed position of FIG. 5 the outer surface of th closing cone 73 engages the angled lower inner edge of the base ring 54. Dropping of the closing cone 73 opens the outlet.

1. An apparatus for making powder sugar from particular crystal or invert sugar, having
a mill,
a rotation-symmetrical collector with a frustoconical downwardly tapering lower part having a lower edge forming a blockable outlet port,
a pneumatic feed line extending from the mill into the collector,
a separator, in particular a filter, in an upper part of the collector, and
a blower for drawing clean air separated from fine particulate matter out of the collector,
characterized by
nozzles (8) for blowing steam into the pneumatic feed line (6) and/or into the mill (3), and
nozzle passages (64) near a lower edge of the frustoconical lower part 16 and serving for blowing air under pressure into the collector (7).

2. The apparatus according to claim 1, characterized by an intake conduit (4) for fresh air opening into an intake (2) of the mill and by a bypass conduit (14) opening into the intake conduit (4) for recirculating clean air.

3. The apparatus according to claim 1 or 2, characterized in that the nozzle passages (64) have at least at their outlets (66) a tangential directional component that are directed at the same orientation relative to the rotation direction of the collector (7).

4. The apparatus according to one of claims 1 to 3, characterized by
a mixing head (15) at a lower edge of the lower part 26,
an annular chamber (52) extending from the nozzle passages (65), and
a lowerable and raisable closing cone (73) that is held by a support (69, 70) against a lower face of the mixing head (15).

5. The apparatus according to claim 4, characterized in that the chamber (52) is connected via a conduit (17) with a pressurized-air supply (18) and that the conduit (17) is provided with a valve (19) that is operated by a controller (20) according to a predetermined program.

6. The apparatus according to one of claims 1 to 5, characterized by a second collector (7) that is also equipped with nozzle passages (64) for blowing in air under pressure.
